(19) United States
(12) Patent Application Publication
(10) Pub. No.: US 2007/0171677 A1
(43) Pub. Date: Jul. 26, 2007

(54) Backlight device for liquid crystal dislay and method for manufacturing the same

(76) Inventors: Tadashi Yano, Kyoto (JP); Akira Hochi, Nara (JP)

Correspondence Address: WENDEROTH, LIND & PONACK L.L.P., 2033 K. STREET, NW, SUITE 800, WASHINGTON, DC, 20006, US

(21) Appl. No.: 10/590,196

(22) PCT Filed: Feb. 2, 2006
(86) PCT No.: PCT/JP06/01782

§ 371 Date: Aug. 22, 2006

(30) Foreign Application Priority Data
Feb. 10, 2005 (JP) 2005-034014

(51) Int. Cl. F21V 14/00

(52) U.S. Cl. 362/614; 362/255

(57) ABSTRACT

A cover layer 21 made of a first transparent resin is formed on outer peripheries of bulbs 25 of plural fluorescent lamps 20 of a backlight 10 for liquid crystal display. The fluorescent lamps 20 are enclosed in the holder member 22 made of a second transparent resin so as to be juxtaposed with each other. The first transparent resin has lower hardness than that of the second transparent resin so as to absorb stresses applied to the fluorescent lamp 20. The first transparent resin has greater heat resistance than that of the second transparent resin so as to suppress alternation such as yellowing due to heat generated by the fluorescent lamps 22.

### TECHNICAL FIELD

The present invention relates to a backlight for a liquid crystal display, and in particular relates to a backlight for a liquid crystal display which can be applied to large-screen liquid crystal displays, and a method for manufacturing the same.

### BACKGROUND ART

There are two general designs for backlights for use in liquid crystal displays, which are so-called “direct types” and the “light guide plate types”.

In the light guide plate type backlight, a fluorescent lamp is placed at an edge of a light guide plate. This arrangement can achieve backlight which is thin and has little brightness non-uniformity. However, due to a limitation on a number of fluorescent lamps which can be installed, when applying a light guide plate type backlight to a large-screen liquid crystal display, uniform brightness over the large screen cannot be secured. Further, the light guide plate type backlights cannot easily be made larger due to increases in weight of the light guide plates.

On the other hand, in the direct type backlight, fluorescent lamps are placed directly below a screen of the liquid crystal display. This arrangement is suited to large displays insofar as the number of fluorescent lamps can be increased according to a screen size to secure high luminance. However, this arrangement involves the brightness non-uniformity cased by differences in brightness among the respective fluorescent lamps and differences in brightness among portions below which the fluorescent lamps are directly placed and portions below which the fluorescent lamps exist.

One method to improve the brightness non-uniformity in the direct type backlights is to set a pitch between fluorescent lamps narrow. However, the narrow pitch cases heats generated by the fluorescent lamps to be a new problem. Further, the brightness non-uniformity can be alleviated by increasing a distance between the fluorescent lamps and a display surface. However, this arrangement causes such problems as a decline in brightness and an increase in an overall thickness of the liquid crystal display.

It has been proposed that a backlight for liquid crystal display has a housing interior of which fluorescent lamps are arranged and filled with a resin so as that the fluorescent lamps are sealed by the resin.

FIG. 12 is a cross sectional view of a liquid crystal display disclosed in Japan Utility Model Application Laid-open Publication No. 4-79330. A backlight 101 is placed directly below a liquid crystal display 100, and a plurality of fluorescent lamps 102 are arranged within a housing 103 of the backlight 101 so as to be juxtaposed with each other. A portion of each of the fluorescent lamps 102 is sealed by a resin 104 filled in the housing 103. Since the resin 104 is a material selected for its high thermal conductivity, heat generated by the fluorescent lamps 102 is conducted by the resin 104 and dissipated from a reflective plate (not shown) formed on a rear face of the housing 103. Because the heat dissipation effect of this arrangement is obtained by filling the interior of the housing 103 with resin 104, an increase in the thickness of the backlight 101 can be avoided.

FIG. 13 is a cross sectional view of a backlight disclosed in Japan Patent Application Laid-open Publication No. 2003-233071. A plurality of fluorescent lamps 102 are arranged within a housing 103 of a backlight 101, and the entirety of each of the fluorescent lamps 102 is sealed by a resin 104 filled in the housing 103. If periphery of the fluorescent lamps 102 inside the housing 103 were filled with air, the difference in refractive indices between air and the glass constituting bulbs of the fluorescent lamps 102 would be large and light generated in the fluorescent lamps 102 and subjected to total reflection within the bulbs would be high. This results in that irradiation efficiency from the fluorescent lamps 102 is lowered, reducing the brightness of the backlight 101. By selecting a material having a refractive index close to the refractive index of the glass constituting the bulbs of the fluorescent lamps 102 as the resin 104 filled in the housing 103, the fraction of light undergoing total reflection is reduced, and the efficiency of irradiation from the fluorescent lamps 102 can be improved.

Growing in size of the backlight increases the number of fluorescent lamps, causing inevitable increasing in weight. In order to lighten the backlight, a lightweight material (for example a resin or the like) is selected as the material for the housing. However, such materials have low mechanical strength, and the housing tends to be deformed by external mechanical stresses. Such deformation of the housing results in such new problems as the brightness non-uniformity and breakage of fluorescent lamps within the housing.

The technology disclosed in Japan Utility Model Application Laid-open Publication No. 4-79330 and Japan Patent Application Laid-open Publication No. 2003-233071 improves heat dissipation efficiency and irradiation efficiency of the fluorescent lamps 102 by filling the housing 103 in the resin, and Japan Patent Application Laid-open Publication No. 5-323312 describes the effectiveness of this technology as a means of obtaining durability against mechanical stress. The backlight structure disclosed in Japan Patent Application Laid-open Publication No. 5-323312 is similar to that shown in FIG. 13.

### DISCLOSURE OF INVENTION

### Problems to be Solved by the Invention

The above-described technique of filling the resin in the housing is an effective means for resolving various problems caused by growing in size of the backlight. However, the present inventors have found that, as the backlights are still made larger and fluorescent lamps become extremely long, due to the weight of the fluorescent lamps itself, a non-negligible amount of “deflection” will occur in the fluorescent lamps, as a result of which new problems not had been recognized by those who skilled in the art will occur. Hereafter, the problems newly discovered by the inventors due to the “deflection” will be described in detail.

FIG. 1A and FIG. 1B show results of tests on deflection amounts of fluorescent lamps performed by the present inventors. FIG. 1A depicts a test method for measuring the amount of deflection of fluorescent lamps 20; FIG. 1B is a graph showing the test results.

As shown in FIG. 1A, both ends of a long fluorescent lamp 20 are supported by supports 30 so as to be placed horizontally on the supports 30. Maintaining this status, the amount of deflection 6 due to the weight of the fluorescent lamp 20 itself is measured. The fluorescent lamps 20 used for measurement three types, having diameters (bulb external diameter) φ and lengths L of φ=3 mm, L=700 mm; φ=4 mm, L =700 mm; and φ=2.5 mm, L=300 mm.

FIG. 1B is a graph in which the measurement results are plotted, taking a distance from a center of a lamp length of the fluorescent lamp 20 to the support portions 30 as a horizontal axis and taking a deflection δ of the fluorescent lamp 20 with respect to the center of the lamp length as a vertical axis. The sign of the horizontal axis in FIG. 1A is positive on the right side and negative on the left side. As shown in FIG. 1B, even for the relatively short fluorescent lamp 20 with length L of 300 mm, the deflection amount δ reaches a maximum of 20 μm. Further, when the length L of the fluorescent lamp 20 is 700 mm, the narrow lamp with the diameter φ of 3 mm has the deflection amount δ reaching a maximum 90 μm.

The deflection amount of the fluorescent lamp 20 changes with the bulb wall thickness, the glass material of the bulb, and other variables in addition to the length and diameter. However, as the backlights further increase in size, it is anticipated that deflection amounts ranging from several percent to more than ten percent of the diameter of the fluorescent lamp 20 will occur as fluorescent lamps 20 are made even longer. As explained in detail below, problems arising from this “deflection” are not recognized, addressed, nor considered at all when using the technique of the conventional art of filling the resin in the housing.

In the case of the techniques disclosed in the Patent Documents 1 to 3, filling of the resin 104 into the housing 103 is performed in a state where a plurality of fluorescent lamps 102 has already been laterally arranged within the housing 103. Specifically, a liquid resin 104 is poured into the housing 103, and thereafter heat is applied to harden the resin 104 and seal the fluorescent lamps 102. Thus, the fluorescent lamps 102 are sealed by the resin 104 in a state where the “deflection” occurs due to the weight of the lamps themselves or gravity. During the hardening by heating, shrinkage of the resin 104 occurs, and due to this shrinkage, stress is applied to the sealed fluorescent lamps 102. As a result, further stress is applied to the bulbs of the fluorescent lamps 102 which have already experiencing the “deflection” due to their own weight. This can cause breakages of the bulbs of fluorescent lamps 102.

Further, during the backlight is operated, further stresses occur due to thermal expansion and thermal shrinkage of the resin 104 upon each switching of the fluorescent lamps 102. Thus, there is a possibility of breakage of bulbs of fluorescent lamps 102 during operation, even when the breakage does not occur at the time of thermal hardening of the resin 104.

The possibility of breakage of bulbs of the fluorescent lamps 102 during manufacture and during operation greatly detracts from reliability of the backlight.

Further, because the fluorescent lamps 102 are sealed by the resin 104 while in a state where the “deflection” occurs due to the weight of the lamps themselves as described above, positional precision of the fluorescent lamps 102 is low. Because of the low positional precision of the fluorescent lamps 102, optical design to reduce drawbacks in the backlight such as the brightness non-uniformity becomes more difficult.

In considering above, an object of the present invention is mainly to provide a backlight for liquid crystal display which affords high durability against stress, high reliability, and easy optical design. Means for Solving the Problems

A first aspect of the present invention provides a backlight for liquid crystal display comprising, a plurality of fluorescent lamps, a cover layer made of a first resin and covering an outer periphery of each of the fluorescent lamps, and a holder member made of a second resin in which the fluorescent lamps with the outer peripheries being covered by the cover layers are enclosed so as to be juxtaposed with each other. Thermal stresses and mechanical stresses applied to the fluorescent lamps can be absorbed by the cover layer while each of the fluorescent lamps is reliably held without position shifts.

In order that the cover layer can reliably absorb the thermal stresses and the mechanical stresses on the fluorescent lamps, it is preferable that hardness of the first resin is lower than that of the second resin. In this specification, the “hardness” of the resin refers to resistance to deformation of an object made of such resin when the stress is applied. Alternatively, the first resin can be a gel-form resin and the second resin can be a rigid resin.

It is preferable that heat resistance of the first resin is greater than that of the second resin. This suppresses deteriorations such as yellowing ant the like due to heat emitted from the fluorescent lamps, resulting in that decrease in brightness and brightness non-uniformity arising from the deterioration of the resin can be prevented. In this specification, the “heat resistance” of a resin refers mainly to resistance against deterioration of chemical properties (as well as physical properties such as mechanical strength) of the resin due to heat.

As combinations of first and second resins satisfying the conditions relating to hardness and heat resistance described above, a silicone resin or fluoride resin may be adopted as the first resin, and an epoxy resin, acrylic resin, or polycarbonate resin may be adopted as the second resin.

By enabling extraction from the holder member of the fluorescent lamps with the outer peripherals being covered by the cover layer, respective fluorescent lamps can be detached from the holder member independently of the other fluorescent lamps. In order to facilitate the extraction of fluorescent lamps, it is preferable that at least one of both ends of each of the fluorescent lamps is projected out of the holder member, and that a thickness of the cover layer is uniform in an elongation direction of the fluorescent lamp.

There are no particular limitations on shape of the fluorescent lamps. The fluorescent lamps may for example comprise straight tube-shaped bulbs. In case of the fluorescent lamp having bulbs of diameter 4 mm or greater, and of length 300 mm or greater, the deflection due to the weight of the lamp itself is remarkable. The present invention is particularly preferably applied to the backlight for liquid crystal display having such size.

It is preferable that the fluorescent lamps with the outer peripheries covered by cover layers are respectively inserted into the accommodation holes formed in the holder member. This arrangement suppresses the amount of the deflection due to the weight of the fluorescent lamps themselves to substantially zero. However, the holder member may be molded by arranging the fluorescent lamps, the outer perimeter of which has already been covered with a cover layer, in a mold or a housing, and injecting the second resin into a cavity or into the housing. Even in the case of such arrangement, the stress absorption effect by the cover layer described above is obtained.

A second aspect of the present invention provides a lighting device comprising, a plurality of fluorescent lamps, a cover layer made of a first resin and covering an outer periphery of each of the fluorescent lamps, and a holder member made of a second resin, in which the fluorescent lamps with the outer peripheries being covered by the cover layers are enclosed so as to be juxtaposed with each other.

A third aspect of the present invention provides a method for manufacturing the above-described backlight for liquid crystal display. The method of manufacture comprises a first step and a second step. In the first step, a first resin is applied to outer peripheries of a plurality of fluorescent lamps to form cover layers which cover the outer peripheries. In the second step, the fluorescent lamps with outer peripheries covered by the cover layers is enclosed in a holder member made of a second resin so as to be juxtaposed with each other.

It is preferable that the second step is executed according to following procedure. First, a first mold having a first depression and a second mold having a second depression are provided. Then, a plurality of inner molds having similar shapes to the fluorescent lamps is arranged within the first or the second depression. Next, after the first and second molds are clamped together, a second resin is supplied into a cavity formed by the first and second depressions, thereby molding a holder member within which the inner molds are sealed. After the second resin is hardened, the holder member is demolded from the first and second molds. Next, the inner molds are extracted from the demolded holder member. Thereafter, the fluorescent lamps with the outer peripheries covered by the cover layers are inserted into a plurality of accommodation holes left in the holder member by the extraction of the inner molds. By the insertion, the cover layers are in close contact with hole walls of the accommodation holes.

As an alternative of the second step, after arranging the fluorescent lamps with outer peripheries covered with the cover layer is arranged in a cavity of a mold or in housing, the second resin may be injected into the cavity or housing to mold the holder member.

According to the present invention, a plurality of fluorescent lamps with outer peripheries covered by cover layers made of a first resin are enclosed in a holder member made of a second resin, heat stresses and mechanical stresses to be applied to the fluorescent lamps can be absorbed by the first resin while each of the fluorescent lamps is reliably maintained a status where position shift does not occur. As a result, a highly reliable backlight for a liquid crystal display can be achieved. In particular, by using as the first resin a material with lower hardness than the second resin, or a gel-form resin, the effect of stress absorption of the cover layer can be enhanced.

Further, by using as the first resin a material with higher heat resistance than the second resin, deteriorations of the first resin such as yellowing and the like due to heat emitted from the fluorescent lamps can be suppressed, resulting in that decrease in brightness and brightness non-uniformity arising from the deterioration of the resin can be prevented. Accordingly, a backlight for liquid crystal display of high quality and with a long lifetime can be achieved.

Further, by making it is possible to extract the fluorescent lamps from the holder member while maintaining the outer periphery covered by the cover layer, each of the fluorescent lamps can be detached from the holder member independently of the other fluorescent lamps. As a result, maintenance properties and manufacturing properties are both improved, in that it is easy to replace only those fluorescent lamps for which breakage or the like has occurred.

Furthermore, a structure, where the fluorescent lamps with the outer peripheries covered by the cover layers are inserted into a plurality of accommodation holes formed in the holder member, can suppress the amount of deflection of the fluorescent lamp due to its own weight to substantially zero, so that optical design of the backlight become easier.

### BRIEF DESCRIPTION OF DRAWINGS

FIG. 1A schematically depicts a method of measurement of an amount of deflection of a fluorescent lamp;

FIG. 1B is a graph showing results of measurements of the amount of deflection of fluorescent lamps;

FIG. 2A is a perspective view showing a backlight 10 for liquid crystal display according to an embodiment of the present invention;

FIG. 2B is a plane view showing the backlight 10 for liquid crystal display according to the embodiment of the present invention;

FIG. 2C is a side view showing the backlight 10 for a liquid crystal display according to the embodiment of the present invention;

FIG. 2D is a side view showing the backlight 10 for liquid crystal display according to the embodiment of the present invention;

FIG. 2E is a cross sectional view along a line II-II in FIG. 2B;

FIG. 2F is a cross sectional view along a line II′-II′ in FIG. 2C;

FIG. 3 is a schematic circuit diagram showing a wiring configuration of the backlight for liquid crystal display according to the embodiment of the present invention;

FIG. 4 is an exploded perspective view showing an example in which a housing is provided for the backlight for liquid crystal display according to the embodiment of the present invention;

FIG. 5A is a perspective view showing molds used to form a cover layer; FIG. 5B is a front view showing the molds used to form a cover layer;

FIG. 6 is an exploded perspective view showing molds used to form a holder member;

FIG. 7 is a perspective view showing a lower-side mold;

FIG. 8 is a perspective view showing an upper-side mold;

FIG. 9A is a cross sectional view showing a state where inner molds are placed in the lower-side mold;

FIG. 9B is a cross sectional view showing a state where clamping of the lower-side and upper-side molds has been completed;

FIG. 9C is a cross sectional view showing a state where demolding of the holder member from the lower-side and upper-side molds has been completed;

FIG. 9D is a cross sectional view showing removal of an inner mold from the holder member;

FIG. 9E is a cross sectional view showing insertion of fluorescent lamps into the holder member;

FIG. 9F is a cross sectional view showing the completed backlight for liquid crystal display;

FIG. 10 is a schematic circuit diagram showing a first alternative of the backlight for liquid crystal display according to the present invention;

FIG. 11 is a schematic circuit diagram showing a second alternative of the backlight for liquid crystal display according to the present invention;

FIG. 12 is a cross sectional view schematically showing configuration of a conventional backlight 101; and

FIG. 13 is a cross sectional view schematically showing the configuration of the conventional backlight 101.

### DESCRIPTION OF REFERENCE NUMERALS

### Best Mode for Carrying Out the Invention

The present inventors reasoned that the conventional method of manufacturing the backlight, where the liquid resin is poured into the hosing followed by heat hardening the resin, can not avoid the generation of stresses due to the shrinkage of resin when hardened. For avoiding the generation of stresses, the present inventors achieve a backlight for liquid display having a novel construction and a method of manufacturing the same.

An embodiment of the present invention will be described with reference to drawings. In the following drawings, elements having substantially the same functions are assigned the same reference symbols for simplifying explanation. It should be noted that the present invention is not limited to the following embodiment.

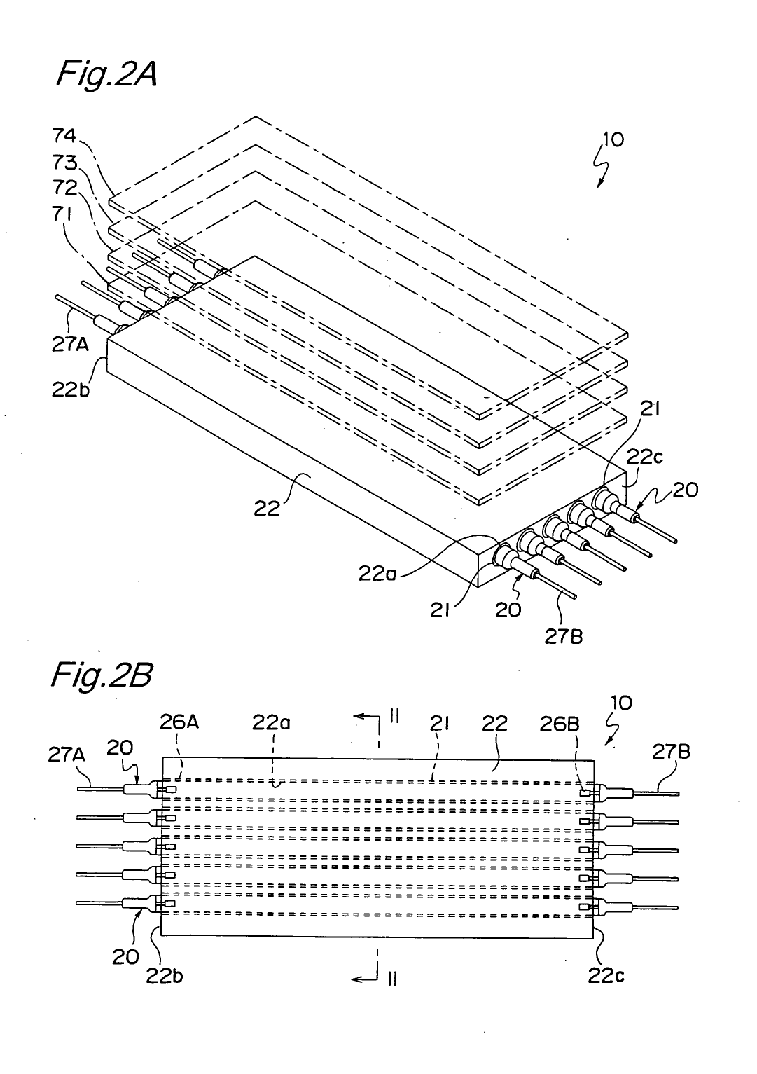

FIGS. 2A to 2F show a configuration of a backlight for liquid crystal display (hereafter merely referred to as a “backlight”) 10 according to an embodiment of the present invention. As shown in FIGS. 2A, 2B, 2D to 2F, a plurality of (in this embodiment, five) fluorescent lamps 20 are arranged so as to be juxtaposed with each other.

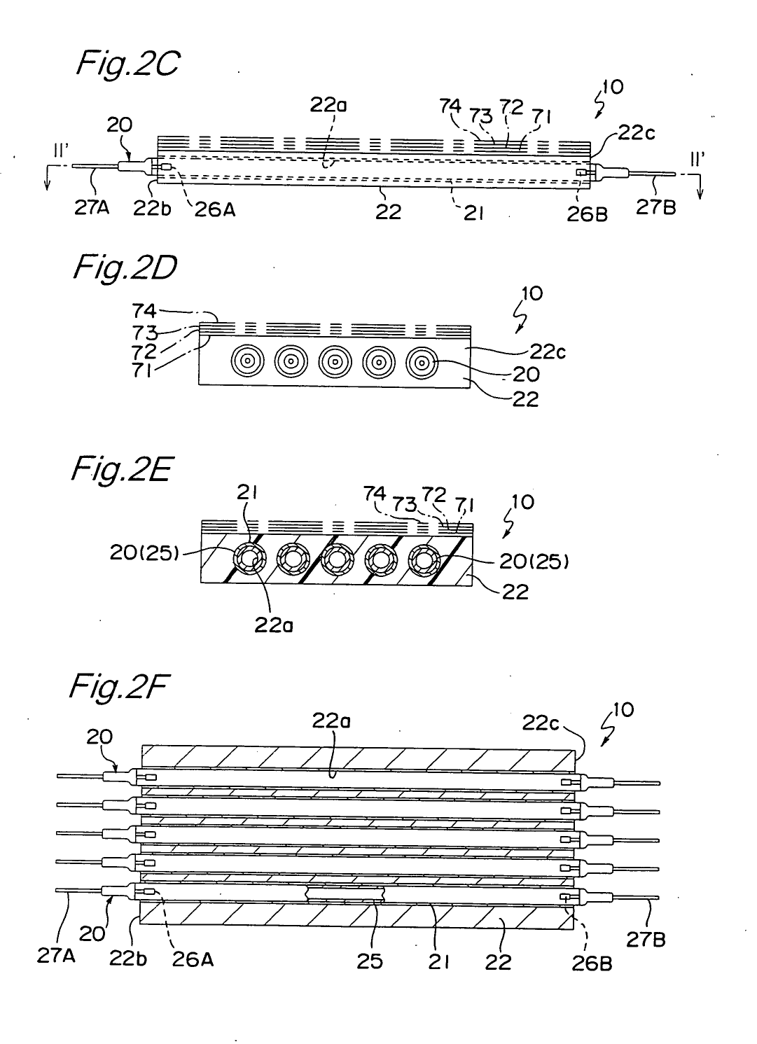

Referring to FIG. 3, the fluorescent lamp 20 is provided with a bulb 25 having a straight tube shape, made of borosilicate glass or another translucent material, and an interior of which functions as a discharge space; a discharge medium (not shown) sealed in the bulb 25, internal electrodes 26A and 26B arranged near end portions inside the bulb 25, and conductive rods 27A, 27B. Distal ends of the conductive rods 27A and 27B is provided with the internal electrodes 26A and 26B whereas proximal ends of the conductive rods 27A and 27B are projected out of the bulb 25. The bulb 25 has a circular cross section, and an outer diameter of the bulb 25 is constant in an axial direction. The cross sectional shape of the bulb 25 is not limited to the circular shape as this embodiment, but can be elliptical, triangular, square, or another shape. Further, so long as detachable from accommodation holes 22a as described latter, the bulb 25 can have a curved profile

As shown in FIGS. 2A to 2F, an entire outer periphery of the bulb 25 of each of the fluorescent lamps 20 is covered with a cover layer 21 made of a first transparent resin. The cover layer 21 is elongated from a vicinity of one end of the bulb 25 to a vicinity of the other end of the bulb 25. A thickness of the cover layer 21 is, for example, approximately 0.1 to 5 mm. In this embodiment, the thickness of the cover layer 21 is 0.5 mm, and is uniform in both an outer circumferential direction of the bulb 25 of the fluorescent lamp 20 and in an elongation direction of the bulb 25. The fluorescent lamps 20 having bulbs 25 with the outer peripheries covered by the cover layers 21 are enclosed in the holder member 22 made of a second transparent resin, in a state where the fluorescent lamps 20 are extended in the same plane so as to be parallel with each other.

In this embodiment, by inserting fluorescent lamps 20, covered with a cover layer 21, into a holder member 22 molded using a second transparent resin, the fluorescent lamps 20 are enclosed in the holder member 22.

In this embodiment, the fluorescent lamps 20 that has been covered with the cover layer 21 is inserted into the holder member 22 that has molded using the second transparent resin, thereby embedding the fluorescent lamps 20 in the holder member 22. The holder member 22 is a single-piece member having a thin or flat, rectangular parallelepiped shape. A plurality of long and thin accommodation holes 22a (in this embodiment, five, corresponding to the number of fluorescent lamps 20) penetrating the holder member 22 from one of opposite side portions 22b and 22c to the other of them are formed so as to be elongated in parallel. Each of the accommodation holes 22a has a circular cross sectional shape with a constant diameter. By inserting the fluorescent lamps 20 into the accommodation holes 22a so that the cover layers 21 are in close contact with hole walls of the accommodation holes 22a, almost the entirety of the bulbs 25 of the fluorescent lamps 20 are enclosed within the holder member 22. Both end portions of the fluorescent lamps 20, that is, tip ends of the pair of conductive rods 27A, 27B are projected out of the side portions 22b and 22c of the holder member 22.

A hardness of the first resin composing the cover layer 21 covering the fluorescent lamps 20 is lower than the hardness of the second resin composing the holder member 22. Here, “hardness” of a resin refers to resistance to deformation of an object made of such resin when a stress is applied. Specifically, the second resin has hardness at least sufficient for the holder member 22 not to be largely deformed by an external force. On the other hand, hardness of the first resin is set such that the cover layer 21 is deformed when thermal or mechanical stresses are acted on the cover layer 21, and by the deformation such stresses are absorbed by the cover layer 21 and do not act on the bulbs 25 of the fluorescent lamps 20. The first resin can be a gel-form resin, and the second resin can be a rigid resin. By covering the outer peripheries of the bulbs 25 of the fluorescent lamps 20 enclosed in the rigid holder member (second transparent resin) 22 with the soft cover layer (first transparent resin) 21, each of the fluorescent lamps 20 can be reliably held without position shift, while the thermal and mechanical stress on the fluorescent lamps 20 are absorbed by the cover layer 21 so that breakage of the bulbs 25 of the fluorescent lamps 20 can be reliably prevented. As a result, the backlight 10 of this embodiment is highly reliable. Further, a structure is employed in which fluorescent lamps 20 with the outer peripheries covered with the cover layer 21 are inserted into the accommodation holes 22a formed in the molded holder member 22, rather than a structure in which the fluorescent lamps 20 are sealed within a resin. This structure effectively suppresses an amount of deflection due to the weight of the fluorescent lamp 20 itself to approximately zero.

Although the holder member 22 has a function of relaxing the external mechanical stresses acting on the fluorescent lamps 20 as explained above, there is no need to employ an excessively hard or rigid resin as the second resin used to form the holder member 22 because the fluorescent lamps 20 are protected from the stresses by the cover layer 21.

In this embodiment, heat resistance of the first transparent resin forming the cover layer 21 is greater than heat resistance of the second transparent resin forming the holder member 22. Here, the “heat resistance” of a resin refers mainly to resistance against deterioration of chemical properties (as well as physical properties such as mechanical strength) of the resin due to heat. Since the cover layer 21 is provided on the outer periphery of the bulbs 25 of the fluorescent lamps 20, and heat generated by the fluorescent lamps 20 is directly transferred to the cover layer 21 during the fluorescent lamps 20 is operated. Thus, by using a resin with high heat resistance as the cover layer 21, in addition to the above-described effect of absorbing stresses, deteriorations such as yellowing and the like of the first transparent resin due to heat emitted from the fluorescent lamps can be prevented, thereby preventing decreases in the brightness and occurrence of the brightness non-uniformity due to the deteriorations

Combinations of the first and second transparent resins which satisfy conditions relating to the hardness and the heat resistance, a silicone resin or fluoride resin can be used as the first transparent resin, and an epoxy resin, acrylic resin, or polycarbonate resin can be used as the second transparent resin. Further, by modifying synthesis conditions of a given resin, the hardness and heat resistance can be changed.

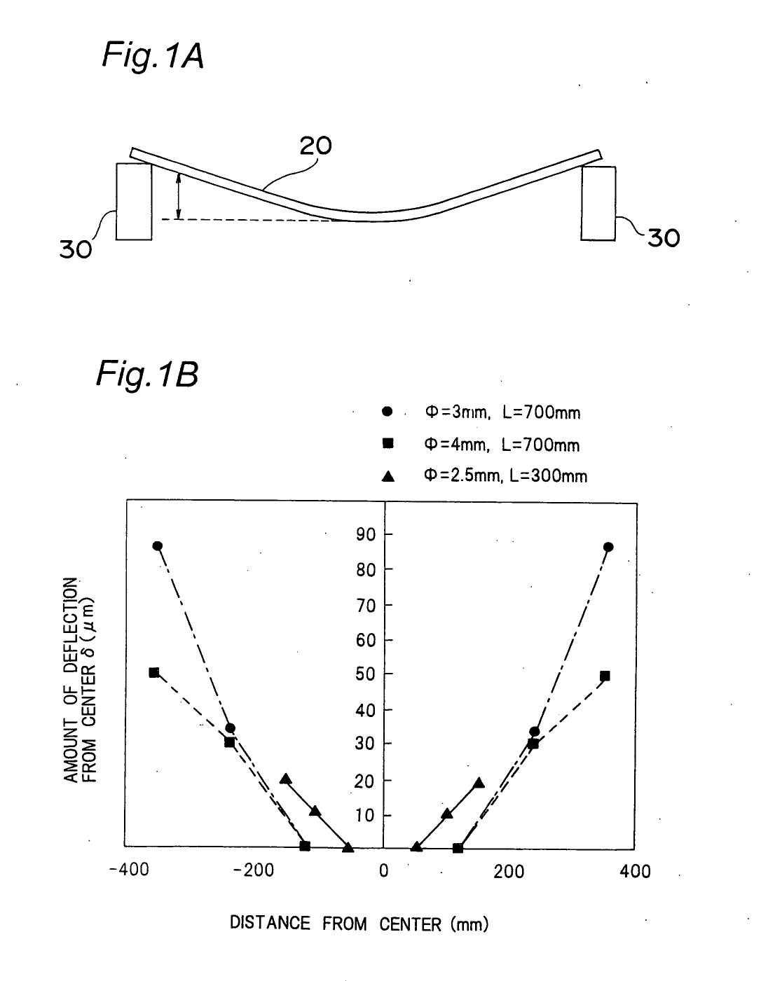

Stress absorption by the first transparent resin 21 in this invention is more effective for longer fluorescent lamps 20. Because the amount of deflection of the fluorescent lamp 20 due to its own weight is smaller for larger diameters of the bulb 25, in this embodiment, it is more appropriate to employ the fluorescent lamp 20 having the diameter (the outer diameter of bulb 25) of 4 mm or less which is showed to be easily subjected to he deflection by the testing results shown in FIGS. 1A and 1B. Similarly, because the amount of the deflection is smaller for shorter length, it is more appropriate to employ the fluorescent lamps 20 having the length of 300 mm or greater which is showed to be easily subjected to he deflection by the testing results shown in FIGS. 1A and 1B.

The fluorescent lamps 20 are detachably inserted into the accommodation holes 22a of the holder member 22. Specifically, by pulling on one end portion of a fluorescent lamp 20 projected from one of the pair of end portions 22b and 22c of the holder member 22, the fluorescent lamp 20 can be extracted from the accommodation hole 22a of the holder member 22, while the outer periphery of the bulb 25 is kept covered by the cover layer 21. Further, after the fluorescent lamp 20 has been extracted from the accommodation hole 22a, the same or other fluorescent lamp 20 can be inserted into the accommodation hole 22a from one or he other of the pair of side portions 22b and 22c, thereby accommodating the fluorescent lamp 20 in the accommodation hole 22a again. At the insertion or the extraction of the fluorescent lamp 20, the other fluorescent lamps 20 are maintained unchanged, enclosed in the holder member 22. Because each of the fluorescent lamps 20 can be inserted into and removed from the holder member 22 independently of the other fluorescent lamps 20 as described, even when replacement of the fluorescent lamp 20 is required due to the breakage and the like, it is required to replace not the entire backlight 10 but the fluorescent lamp 20 in which defection occurs, achieving high maintenance properties and manufacturing properties.

When the backlight 10 of this embodiment is employed to a liquid crystal display, optical members are placed on a top face (on the liquid crystal display side) of the backlight 10. Specifically, as shown in FIGS. 2A and 2C to 2F, a diffusion plate 71, diffusion sheet 72, lens sheet 73, and polarizing plate 74 are layered on the top face of the holder member 22 made of the second transparent resin so as to function integrally with the holder member 22.

The fluorescent lamps 20 enclosed in the holder member 22 of the backlight 10 can be activated by electrical connection to lighting circuits 80 and wiring 81 as shown in FIG. 3. The wiring 81 is connected to connection terminals (not shown) provided at the tips of the conductive rods 27A and 27B of the fluorescent lamps 20.

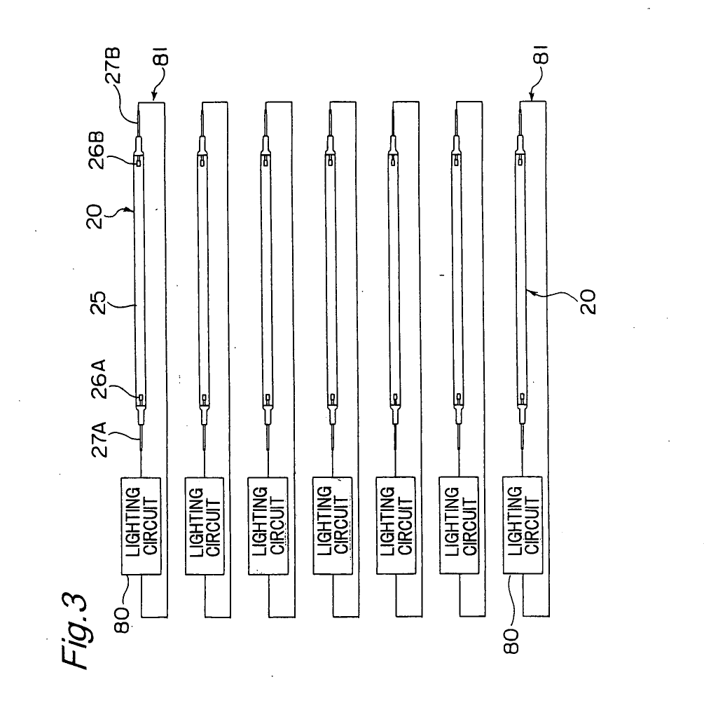

A structural characteristic of the backlight 10 of the present embodiment lies not in that the folder member 22 made of the second transparent resin itself functions to hold the fluorescent lamps 20, instead of that a housing for supporting the fluorescent lamps 20 is filled with the resin. This structural characteristic can avoid stresses which would inevitably act on the fluorescent lamps when the liquid resin is poured into the housing accommodating the fluorescent lamps followed by thermal hardening according the conventional are. Further, in case that the housing is filled with the resin, the housing needs to have a sealed construction, resulting in a complex construction. In contrast to this, the backlight 10 of this embodiment does not need such housing with the complex construction. However, as shown in FIG. 4, the molded holder member 22 may be accommodated in a rigid housing 28 in order to further enhance durability against mechanical stresses. The housing 28 comprises a main unit 28A which surrounds the holder member 22 so as to expose the top face and the pair of side portions 22b and 22c, and side-wall members 40B and 40C which close opposing open ends of the main unit 28A. Formed in the side-wall members 28B and 28C are insertion holes 28a into which the conductive rods 27A and 27B of the fluorescent lamps 20 are inserted so as to be extended out of the housing 28.

Then, a method of manufacturing the backlight 10 of this embodiment will be explained.

The method comprises a step of supplying the first transparent resin to outer peripheries of the bulbs 25 of the fluorescent lamps 20 to form the cover layers 21 (first step), and a step of enclosing the fluorescent lamps 20 with the outer peripheries covered by the cover layers 21 in the holder member 22 (second step).

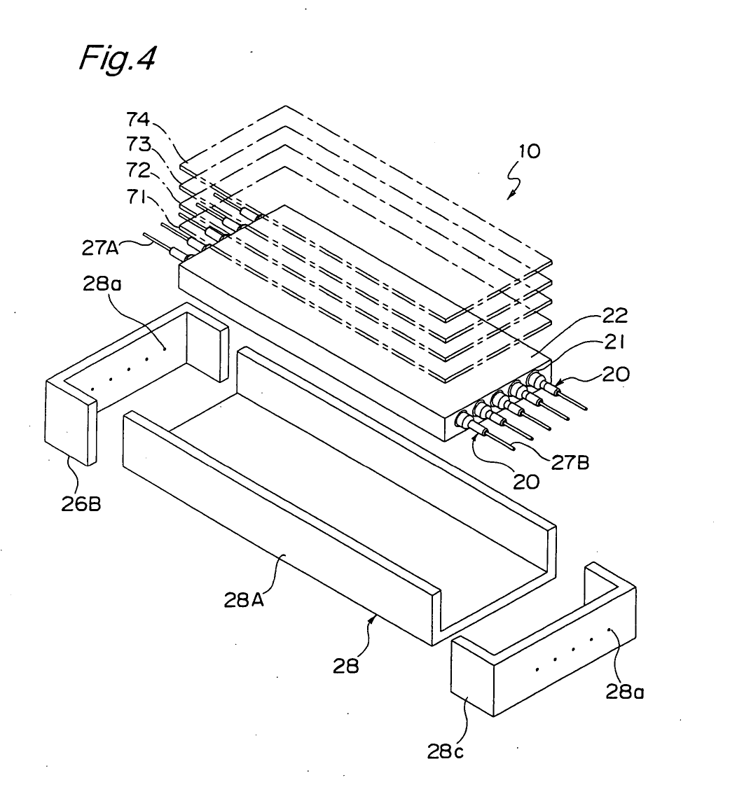

Firstly, the first step will be explained. Referring to FIG. 5A, formed in abutting faces 40a of the first and second molds 40A and 40B for the first process are semicircular-groove shaped depressions 40b. Each of the depressions has a diameter larger than the outer diameter of the bulb 25 of the fluorescent lamp 20. An upper end of the depression 40b is opened, whereas an accommodation recess 40c is provided in a lower end to accommodate the end portion of the fluorescent lamp 20 so as to be in close contact. Further, in a lower end portion of the abutting face 40a of the first mold 40A, a resin pathway groove 40d to serve as a resin inlet 41 (refer to FIG. 5B) when the molds are clamped is formed,

The first and second molds 40A and 40B are brought together in contact at the abutting faces 40a and clamped so that the end portion of the fluorescent lamp 20 is accommodated in the accommodation recess 40c. A long, thin circular-columnar cavity 42 is formed by the depressions 40b of the first and second molds 40A and 40B, and the bulb 25 of a fluorescent lamp 20 is arranged in the center thereof. The cover layer 21 is formed in a thin ring-shaped gap between the bulb 25 and walls of the cavity 42. In other words, a distance between the bulb 25 and the walls of the cavity 42 corresponds to the thickness of the cover layer 21. As indicated by an arrow 43, the first transparent resin is injected from the resin inlet 41. As the first transparent resin is injected, air within the cavity 42 is discharged from the opened upper end of the cavity 42 as indicated by an arrow 44. After the first resin is hardened, the fluorescent lamp 20 is demolded from the molds, the fluorescent lamp 20 having the bulb 25 covered with the cover layer 21 is obtained. By the above procedure, the cover layers 21 made of the first transparent resin are provided on all the fluorescent lamps 20. The cover layer 21 may however be formed by other methods such as application.

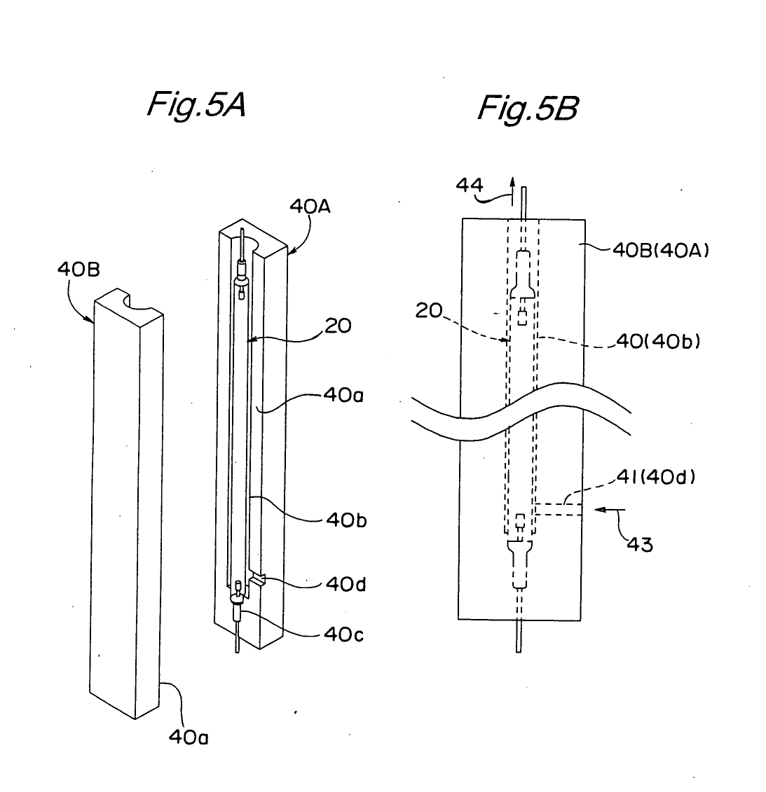

Then, the second step will be explained. Referring to FIG. 6, a mold 50 used in the second step includes first and second molds 51A, 51B, and inner molds 52 in a number corresponding to that of fluorescent lamps 20 to be enclosed within the holder member 22 (in this embodiment, five).

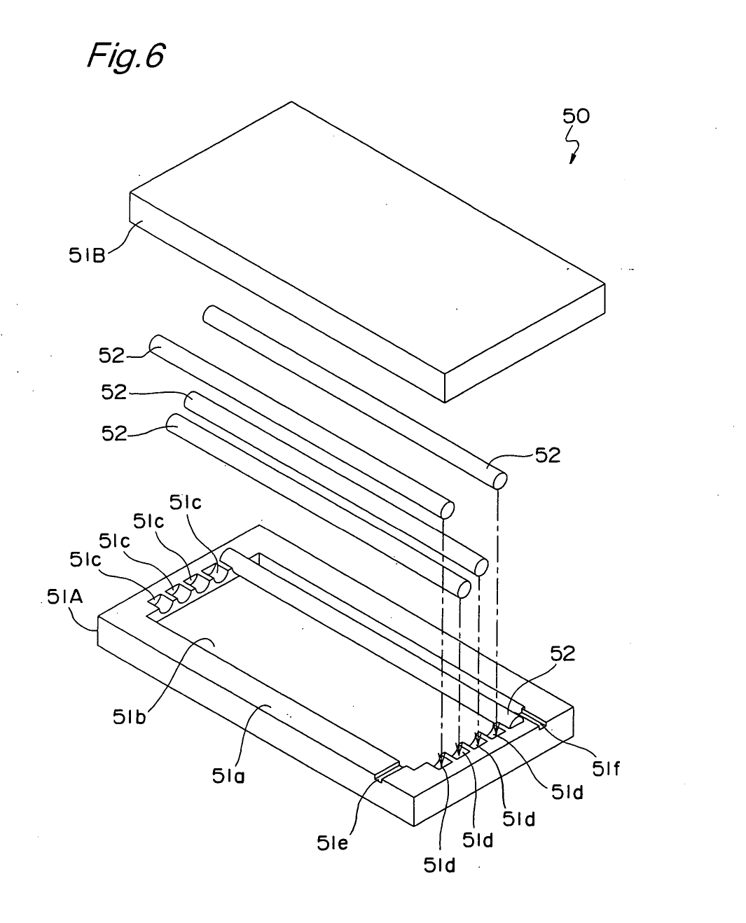

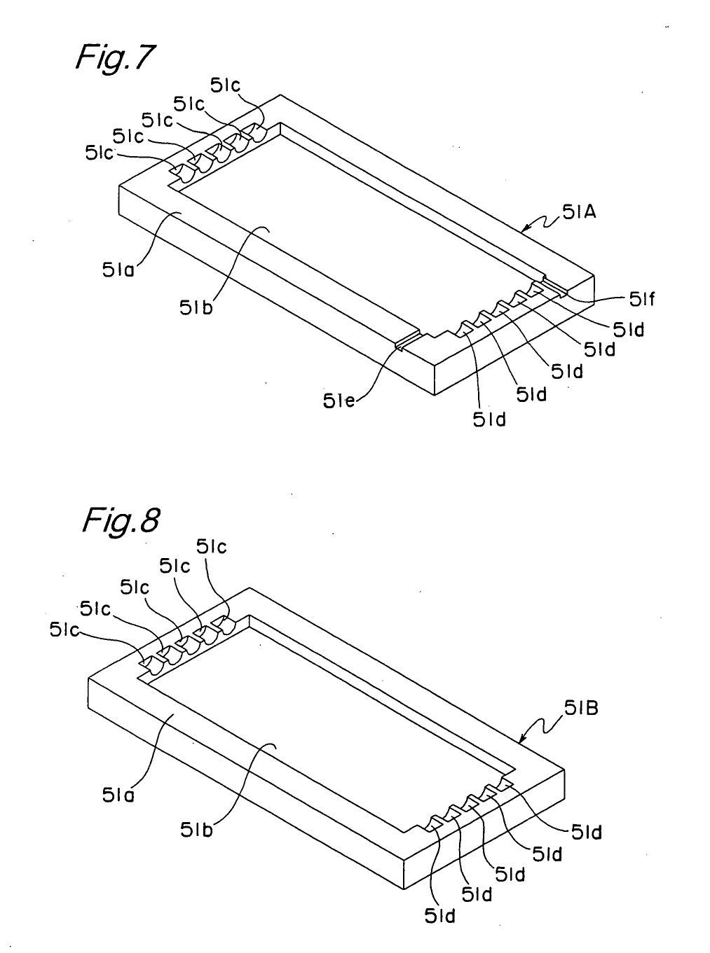

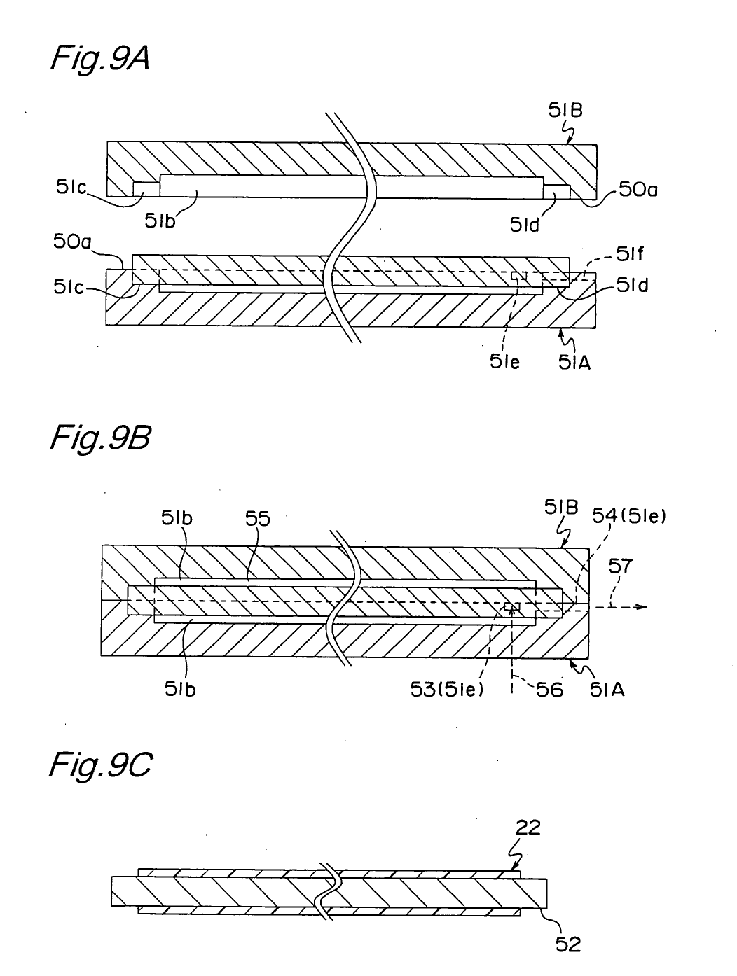

Referring also to FIG. 7, a depression (first depression) 51b with a flattened rectangular parallelepiped shape is formed in an abutting face 51a of the first mold 51A. Further, semicircular holding grooves 51c and 51d respectively having a diameter matching an outer diameter of the inner mold 52 are provided in the abutting face 51a of the first mold 51A. The holding grooves 51c and 51d in a number corresponding to that of inner molds 52 (in this aspect, five) are extended outward from a pair of side walls of the depression 51b opposing to each other in a right-left direction in FIG. 7. Each of the pairs of opposing holding grooves 51c, 51d is positioned on a single straight line as seen in plane view. Further, formed in the abutting face 51a of the first mold 51A are a resin pathway groove 51e serving as an inlet 53 for the second transparent resin (see FIG. 9B), and a resin pathway groove 51f serving as an outlet 54 for the second transparent resin (see FIG. 9B). Referring to FIG. 8, the structure of the second mold 51B is the same as that of the first mold 51A, except for that the resin pathway grooves 51e, 51f are not formed. A depression (second depression) 51b and holding grooves 51c, 51d are formed in an abutting face 51a.

Referring to FIG. 6, the inner molds 52 are shaped similarly to the fluorescent lamps 20, and more specifically have a straight circular columnar shape with a constant diameter. An outer diameter of each of the inner mold 52 is set to be substantially the same as the outer diameter (including the thickness of the cover layer 21) of the bulb 25 of the fluorescent lamp 20. Further, a length of the inner mold 52 is longer than that of the depression 40b in a right-left direction in FIG. 6, and is set to be substantially equal to a distance between end faces of the pairs of opposing holding grooves 51c and 51d.

First, as shown in FIG. 9A, each of the inner molds 42 is arranged in the depression 51b of the first mold 51A. Specifically, the two end portions of the inner molds 42 are accommodated by pairs of holding grooves 51c and 51d. A gap is formed between a bottom face of the depression 51b and each of the inner molds 42. The inner molds 52 may be arranged in the depression 51b of the second mold 51B, rather than in the first mold 51A.

Then, as shown in FIG. 9B, after the first and second mold 51A and 51B are clamped, the second transparent resin is supplied to a cavity 55 formed by the depressions 51b of the first and second molds 51A, 51B so that the resin seals the inner molds 52. As indicated by an arrow 56, the second transparent resin is injected from the inlet 53. Air and excess second transparent resin in the cavity 55 are discharged from the outlet 54 as indicated by an arrow 57. When a thermosetting resin is employed as the second transparent resin for example, heat application to the first and second molds 51A and 51B hardens the second resin in the cavity 55 so as to form the holder member 22 and to seal the inner molds 52 therewithin.

Following to this, as shown in FIG. 9C, the resin molded member, i.e., the holder member 22, within which the inner molds 42 are sealed, is demolded from the first and second molds 51A and 51B.

Then, as shown in FIG. 9D, the plurality of inner molds 42 are extracted from the demolded holder member 22. Accommodation holes 22a are left at the portions from which the inner molds 52 are extracted. Employing a material with an excellent releasing performance as the second resin facilitates the demolding of the holder member 22 from the first and second molds 51A and 51B as well as the extraction of the inner molds 52 from the holder member 22.

Finally, as shown in FIG. 9E, the plurality of fluorescent lamps 20 covered with the cover layer 21 made of the first transparent resin are inserted into the plurality of accommodation holes 22a formed in the holder member 22 by the extraction of the inner molds 52. The cover layer 21 on the inserted fluorescent lamps 20 becomes in close contact with the hole walls of the accommodation holes 22a. When all the fluorescent lamps 20 have been inserted into the accommodation holes 22a, the backlight 10 is completed as shown in FIG. 9F, in which the a plurality of fluorescent lamps 20 covered with the cover layers 21 made of the first transparent resin are enclosed in the holder member 22 made of the second transparent resin.

As described in detail above, in the method according to this embodiment, the holder member 22 is not molded by filling a resin into a housing in which the fluorescent lamps 20 have been placed; instead, the backlight 10 is manufactured by inserting the fluorescent lamps 20 covered with the cover layer 21 into the accommodation holes 22a oft the holder member 22 that have already molded using the mold 50 (see FIG. 6). Thus, mechanical stresses due to shrinkage of resin and the like do not act on the fluorescent lamps 20 during manufacturing of the backlight 10.

By providing protrusions and depressions in advance on the surfaces of the first and second molds 51A and 51B, the surface of the holder member (resin molded member) 22 can be embossed, thereby making the backlight 10 exercise diffusion effects.

Although the preferred embodiment of the invention has been described above, the invention is not limited thereto, and of course various modifications are possible. For example, the stress absorption effect of the present invention can be effective not only for large-size liquid crystal displays, but also for small-size liquid crystal displays especially when thickness of the glass of fluorescent lamp is reduced for weight saving of the backlight.

Further, the backlight 10 of the present invention is not limited to those manufactured by the method of the embodiment. For example, the plurality of fluorescent lamps 20 covered by the cover layers 21 made of the first transparent resin, may be arranged within a mold or housing, followed by that the second transparent resin is supplied to the cavity or the housing interior so as to form the holder member 22. When employing this manufacturing method, the cover layer 21 functions to absorb the mechanical stresses arising during molding of the holder member 22 by the second transparent resin and the thermal stresses during operation, thereby breakage of the fluorescent lamp 20 is prevented.

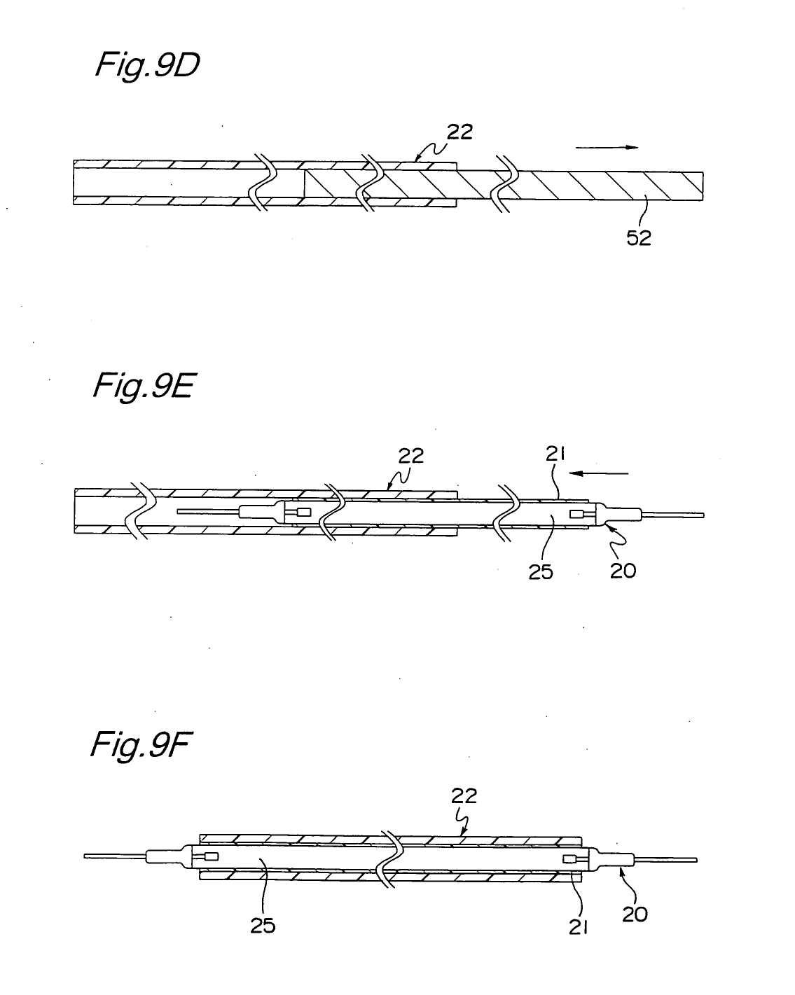

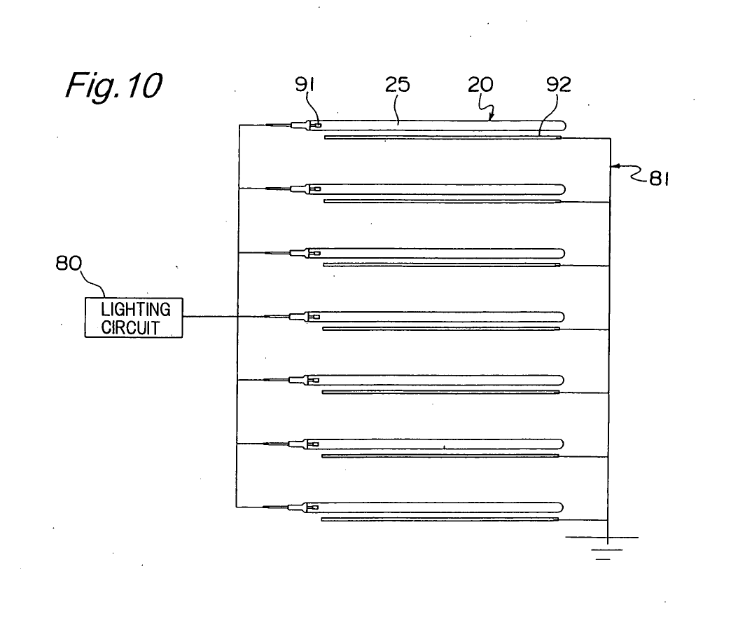

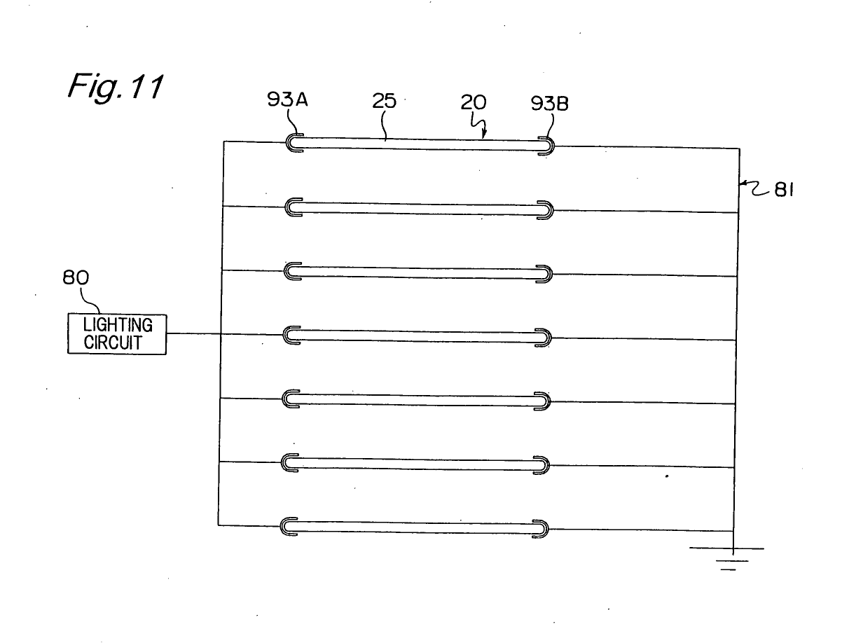

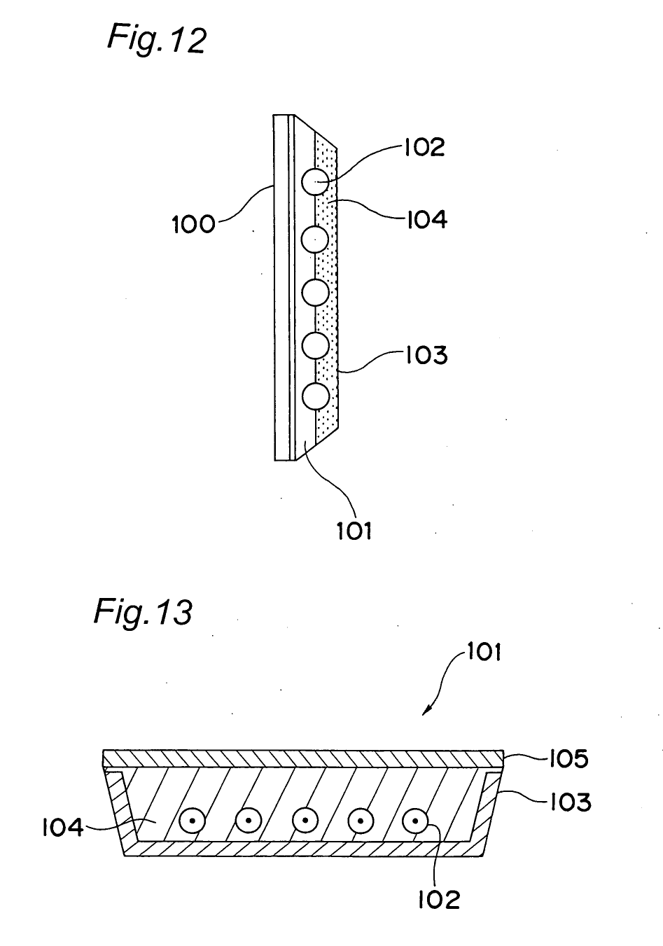

Further, the fluorescent lamps 20 may comprise internal electrodes 91 arranged within a bulb 25 and external electrodes 92 arranged outside the bulb 25 as shown in FIG. 10, or may comprise a pair of external electrodes 93A and 93B arranged outside both ends of the bulb 25 as shown in FIG. 11.

Furthermore, the present invention is not limited to the backlight for liquid crystal display, but can be applied to thin illumination devices used as illumination for signs and the like.

The present invention has been perfectly described with reference to the accompanying drawings, however, it is obvious to those skilled in the art that various alterations and modifications are possible. Therefore, it should be construed that such alterations and such modifications are also included in the present invention, in so far as they are not beyond the spirit and the scope of the present invention.

1-15. (canceled)

16. A backlight for liquid crystal display, comprising:
a plurality of fluorescent lamps;
a cover layer made of a first resin and covering an outer periphery of each of the fluorescent lamps; and
a holder member made of a second resin in which the fluorescent lamps with the outer peripheries being covered by the cover layers are enclosed so as to be juxtaposed with each other,
wherein the fluorescent lamps are enclosed in the holder member so that they can be extracted from the holder member with the outer peripherals being kept covered by the cover layer.

17. The backlight for liquid crystal display according to claim 16, wherein hardness of the first resin is lower than that of the second resin.

18. The backlight for liquid crystal display according to claim 16, wherein the first resin is a gel-form resin and the second resin is a rigid resin.

19. The backlight for liquid crystal display according to claim 16, wherein heat resistance of the first resin is greater than that of the second resin.

20. The backlight for liquid crystal display according to claim 17, wherein the first resin is a silicone resin or a fluoride resin, and
wherein the second resin is an epoxy resin, an acrylic resin, or a polycarbonate resin.

21. The backlight for liquid crystal display according to claim 16, wherein at least one of both ends of each of the fluorescent lamps is projected out of the holder member.

22. The backlight for liquid crystal display according to claim 21, wherein a thickness of the cover layer is uniform in an elongation direction of the fluorescent lamp.

23. The backlight for liquid crystal display according to claim 22, wherein a diameter of a bulb of the fluorescent lamps is 4 mm or greater, and the length of the fluorescent lamps is 300 mm or greater.

24. The backlight for liquid crystal display according to claim 16, wherein a plurality of accommodation holes are formed in the holder member, and
wherein the fluorescent lamps with the outer peripheries covered by the cover layers are enclosed in the holder member by respectively being inserted into the accommodation holes so that the cover layers are in close contact with hole walls of the accommodation holes.

25. The backlight for liquid crystal display according to claim 24, wherein the fluorescent lamps are detachably inserted into the accommodation holes.

26. The backlight for liquid crystal display according to claim 25, wherein the accommodation holes are formed so as to penetrate the holder member from one side to the other side, and
wherein the fluorescent lamps are inserted into the accommodation holes so that both ends thereof are projected out of the holder member from the sides.

27. A lighting device, comprising:
a plurality of fluorescent lamps;
a cover layer made of a first resin and covering an outer periphery of each of the fluorescent lamps; and
a holder member made of a second resin, in which the fluorescent lamps with the outer peripheries being covered by the cover layers are enclosed so as to bejuxtaposed with each other.

28. A method of manufacturing a backlight for liquid crystal display, comprising:
applying a first resin to outer peripheries of a plurality of fluorescent lamps to form cover layers which cover the outer peripheries; and
enclosing the fluorescent lamps with the outer peripheries covered by the cover layers in a holder member made of a second resin so as to be juxtaposed with each other
wherein the application of the first resin to the outer peripheries to fluorescent lamps comprises:
providing a first mold having a first depression and a second mold having a second depression;
arranging a plurality of inner molds having similar shapes to the fluorescent lamps in the first or second depression;
clamping the first and second molds together followed by supplying of a second resin into a cavity formed by the first and second depressions, thereby molding a holder member within which the inner molds are sealed;
demolding the holder member with the inner molds sealed therein from the first and second molds;
extracting the inner molds from the demolded holder member; and
inserting the fluorescent lamps with the outer peripheries covered by the cover layers into a plurality of accommodation holes left in the holder member by the extraction of the inner molds so that the cover layers are in close contact with hole walls of the accommodation holes.
